(19) United States
(12) Patent Application Publication
(10) Pub. No.: US 2005/0014922 A1
(43) Pub. Date: Jan. 20, 2005

(54) Apparatus and process for batchwise polycondensation

(75) Inventors: Bernd Muller, Marl (DE); Tim Popken, Friesoythe (DE); Rolf Hirsch, Marl (DE); Edgar Trost, Haltern am See (DE); Georg Becker, Witten (DE); Martin Bartmann, Recklinghausen (DE); Hans-Dieter Zagefka, Haltern am See (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Degussa AG, Duesseldorf (DE)

(21) Appl. No.: 10/891,134

(22) Filed: Jul. 15, 2004

(30) Foreign Application Priority Data
Jul. 15, 2003 (DE) 10331952.2

(51) Int. Cl. C08G 63/00; C08G 69/00; C08G 63/16; C08G 63/18; C08G 67/00

(52) U.S. Cl. 528/271; 528/308; 422/131

(57) ABSTRACT

The invention relates to an apparatus and to a process for batchwise preparation of polycondensation polymers having an intrinsic viscosity of from 50 to 150 cm³/g at the particular polycondensation temperature.

The invention relates to an apparatus and to a process for batchwise preparation of polycondensation polymers having a dynamic viscosity of from 10 to 750 Pa·s at the particular polycondensation temperature. These are prepared from low molecular weight oligomers (which are prepared beforehand in any stirred reactor) by condensation in a vertical, conical reaction vessel provided with a heating/cooling jacket, equipped with a stirrer apparatus suitable for high viscosities, for example a single or double helix which may additionally be heatable.

Prior Art

Reactors and processes for batchwise preparation of condensation polymers, for instance polyesters, in the melt, and also the granulation which is effected on completion of the polycondensation, are well known. A batchwise method is particularly advantageous when the product composition is frequently varied and the change between products of different composition has to be effected rapidly and substantially without losses. The apparatus developed for the continuous condensation polymerization, as listed, for example, in DE-A 197 06 901 A1, are generally unsuitable for batchwise operation, since they have insufficient vessel volume and are difficult to empty of residues. In addition, these reactors are optimized to a particular viscosity gradient which occurs in the production of a certain polyester. Using the example of mixed polyesters, a typical batchwise process for condensation polymerization will be described.

Mixed polyesters consisting of one or more aliphatic or aromatic diol components and one or more aliphatic or aromatic dicarboxylic acid components of a high average molecular weight are typically prepared in at least two reaction steps. In the first reaction step, a low molecular weight intermediate is prepared with an excess of diol and is freed of excess diol in a second, final condensation step and reacts further to high molecular weights. Further postcondensation steps, also in the solid phase, may follow if necessary.

While the first reaction step can be carried out in customary stirred tank reactors, the increasing viscosity in the course of the final condensation and the need to substantially remove the excess of the diol components, some of which are high-boiling, requires the use of special reactors. In addition to ensuring a very good vacuum in the range from <1 to 3 mbar, sufficient mixing of the melt and also effective destruction of a foam on the melt surface which hinders the evaporation have to be guaranteed. Foams can occur occasionally at moderate viscosities during the polycondensation reaction. In addition, good temperature control of the process has to be ensured, since heat has to be introduced into the melt in the initial phase of the condensation polymerization in order to enable the evaporation of excess diol. In the later phases of the polycondensation reaction, the stirrer unit introduces heat mechanically into the highly viscous melt, which has to be removed again effectively in order to prevent localized overheating which is associated with quality reductions in the product. The polymer melt which becomes more viscous at the wall as a result of the cooling additionally has to be removed by a close-clearance stirrer in order to guarantee good heat transfer.

For the batchwise preparation of high molecular and therefore highly viscous polyesters, some special reactors have been developed. Mention should be made here of conventional stirred tanks having special stirrers suitable for high viscosities (cf., for example, U.S. Pat. No. 4,022,438 or U.S. Pat. No. 6,149,296) which guarantee the appropriate mixing; annular disk reactors which draw films out of the melt to improve the evaporation (DE-A-100 01 477 A1) or self-cleaning kneaders (for example U.S. Pat. Nos. 5,934,801 and 5,121,992), which ensure particularly good cleaning of the walls and the internals.

Conventional stirred tanks have the disadvantage of an unfavorable surface area/volume ratio, which causes long reaction times. The consequence of long reaction times is a reduction in the quality of the end product, caused by long residence times at high temperature and characterized by an increase in the acid content and/or a reduction in the melt temperature. Attempts have been made to improve this, for example, by tilting such a reactor (EP 0 753 344 A2). However, this brings grave disadvantages as a result of complicated mechanics and uncertainties in the control of transverse forces and imbalances.

Annular disk reactors and self-cleaning kneaders have the disadvantage of high specific apparatus costs. For the range of intrinsic viscosities between 50 and 150 cm³/g which is of commercial interest, as are required, for example, in the pressure-sensitive adhesive sector, the use of these reactors is hindered by excessively high apparatus costs. Also disadvantageous is the inability of this apparatus to effectively destroy foams which sometimes occur during the condensation polymerization, which reduces their effectiveness temporarily in the course of evaporation. The combination of these features means that these two reactor types are of interest only for very highly viscous condensation polymers. However, at these very high viscosities, the virtually complete emptying of residues, as required for a qualititatively high-value product, characterized by a low acid number and long storage stability, is again problematic.

### OBJECT OF THE INVENTION

It is an object of the invention to find a reactor for the final condensation of mixed polyesters in a range of intrinsic viscosities of from 50 to 150 cm³/g which satisfies the above-mentioned demands, i.e. ensures not only good emptying of residues, but also good mixing and foam destruction and thus rapid reaction progress in the final condensation of mixed polyesters. The disadvantages which are likewise described above should be avoided. It has been possible by an apparatus and a process according to the claims to overcome the disadvantages of the prior art.

It has now been found that, in the batchwise preparation of condensation polymers from an oligomeric precursor with elimination and evaporation of low molecular weight condensation products, an apparatus is suitable which is of conical shape, jacket-heated, and equipped with a helical or double-helical stirrer which may additionally be heated, and the opening angle (α) of the cone is from 20 to 120°, preferably from 30 to 60°.

The helical or double-helical stirrer has a gradient (angle to the horizontal) between 12 and 75°, preferably between 15 and 45°.

Instead of the helical or double-helical stirrer, a (V-shaped) anchor stirrer adapted to the vessel cross section may be used and may be equipped with additional guide plates which bring about conveying in the axial direction.

The upper region of the vessel which is likewise equipped with a heating jacket may have a cylindrical design and the cylindrical section (h_{z}) may have a height which corresponds to from 0 to 1.6 times, preferably from 0 to 0.8 times, the height of the conical section (hₖ).

The stirrer may be driven in such a way that its rotation rate may be varied in stages or steplessly and also be moved counter to the original sense of rotation to empty the apparatus.

The vertical position of the stirrer may be varied in order to adjust the separation of the stirrer from the wall between 3 and 25 mm, preferably 4 and 15 mm.

It has been found that, surprisingly, this apparatus designed for drying and mixing tasks of solids is suitable for the object of the invention. The substantially conical reactor ensures very good emptying of residues, as absolutely necessary for frequent product changes in batchwise operation.

During the initial phase of the polycondensation reaction, a fast-running stirrer can form a slight vortex and can firstly increase the surface area available for evaporation by the stirrer mechanism distributing the melt over the entire internal surface of the apparatus and often renewing this film. Secondly, the film which forms on the melt is effectively destroyed by the rapid stirrer movements and the centrifugal forces, and also shear forces between internal wall of the apparatus and stirrer, which occur. The stirrer rotation rate can be reduced with rising viscosity, since the foam formation falls. This keeps the output demand for the stirrer motor within an acceptable range and simultaneously reduces the excessive input of mechanical energy into the melt which, despite controlled temperature of the reactor, might lead to overheating.

It has now been found that, surprisingly, this conical apparatus designed for drying and mixing tasks is distinctly superior in terms of reaction time and product quality when used as a polycondensation reactor both to a horizontal single-shaft kneader (cf. Example 2) and to a conventional stirred autoclave which is currently used as shown in the examples which follow.

### EXAMPLE 1

A vertical mixer was charged with 80 kg of a precursor which had been prepared by reacting 38.5 kg of 1,4-butanediol, 21.9 kg of adipic acid and 37.3 kg of dimethyl terephthalate with elimination of appropriate amounts of methanol and water at atmospheric pressure and 190° C., and brought to the polycondensation temperature of approx. 240° C. After 20 ppm of Ti had been added as a catalyst (as tetrabutyl orthotitanate, based on the total mass), the pressure in the reactor was reduced to 2 mbar and 1,4-butanediol was distilled off. The rotation rate of the stirrer was gradually reduced from initially 135 min⁻¹ to 70 min⁻¹ at the end of the experiment. No significant foam layer on the melt could be observed. After a reaction time of 3.5 h, an on-spec polycondensation product having an acid number of 0.47 mg KOH·g⁻¹ and an intrinsic viscosity of 100 cm³·g⁻¹ was obtained.

### Example 2

### (Comparative Example)

A horizontal single-shaft kneader from List AG, Arisdorf, disclosed, for example, by U.S. Pat. No. 5,121,922 and U.S. Pat. No. 5,934,801, was charged with 80 kg of the same precursor as detailed in Example 1 and brought to the polycondensation temperature of approx. 240° C. After 20 ppm of Ti as a catalyst had been added, the pressure in the reactor was reduced to 2 mbar and 1,4-butanediol was distilled off. The rotation rate was 50·min⁻¹. During the polycondensation, a marked foam carpet formed on the melt surface. After a reaction time of 5 h, a product having an acid number of 0.40 mg KOH·g⁻¹ and an intrinsic viscosity of 77 cm³·g⁻¹ was obtained. This product does not conform to the specifications, since the desired degree of polycondensation could not be achieved within an acceptable reaction time.

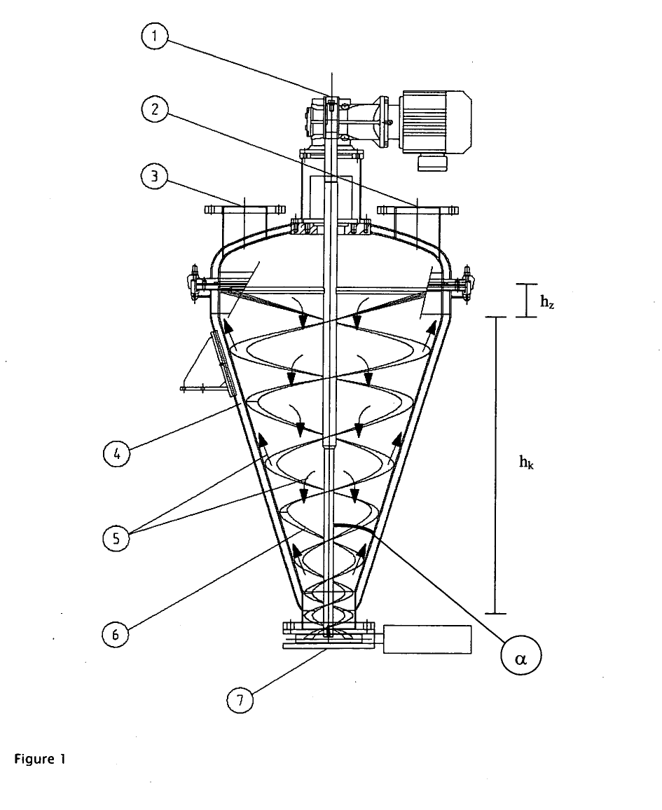

FIG. 1 shows one embodiment of the apparatus. A drive motor (1) drives a double-helical mixer (6), and the rotation rate can be controlled. The precursor is introduced into the apparatus via the fill nozzle (2). The volatile condensation products leave the apparatus via the vapor nozzle (3). The apparatus is heated using a jacket (4). The flow direction of the product is indicated using arrows (5). At the edge, the reaction mixture is moved upward by the stirrer (6) and flows back downward in the center close to the drive shaft. After the end of the polycondensation, the product is discharged via a discharge valve (7), in the course of which the stirrer (6) can be used in support by working in the reverse sense of rotation, so that the polycondensate is conveyed downward on the reactor wall.

1-20. (canceled)

21. An apparatus configured to perform batchwise preparation of condensation polymers from an oligomeric precursor with elimination and evaporation of low molecular weight condensation products, comprising:
a conical, jacket-heated vessel configured to perform a polycondensation reaction, the vessel having a conical section with an opening angle between 20 and 120°; and
a helical or double-helical stirrer disposed in the vessel.

22. The apparatus according to claim 21, wherein the opening angle is between 30 and 60°.

23. The apparatus according to claim 21, wherein the helical or double-helical stirrer has a gradient of between 12 and 75°.

24. The apparatus according to claim 21, wherein the helical or double-helical stirrer has a gradient of between 15 and 45°.

25. An apparatus configured to perform batchwise preparation of condensation polymers from an oligomeric precursor with elimination and evaporation of low molecular weight condensation products, comprising:
a conical, jacket-heated vessel configured to perform a polycondensation reaction, the vessel having a conical section with an opening angle between 20 and 120°; and
a V-shaped anchor stirrer adapted to the vessel cross section and configured to bring about conveying in an axial direction.

26. The apparatus according to claim 21, wherein an upper region of the vessel comprises a cylindrical section equipped with a heating jacket, the cylindrical section having a height less than or equal to 1.6 times a height of the conical section.

27. The apparatus according to claim 21, wherein an upper region of the vessel comprises a cylindrical section equipped with a heating jacket, the cylindrical section having a height less than or equal to 0.8 times a height of the conical section.

28. The apparatus according to claim 21, wherein the stirrer is configured to be driven to change a rotation rate in stages or steplessly and to move counter to an original direction of rotation.

29. The apparatus according to claim 21, wherein the stirrer is configured to be positioned to vary a vertical position of the stirrer to move the stirrer between 3 and 25 mm from a wall.

30. The apparatus according to claim 21, wherein the stirrer is configured to be positioned to vary a vertical position of the stirrer to move the stirrer between 4 and 15 mm from a wall.

31. A process for batchwise preparation of condensation polymers from an oligomeric precursor with elimination and evaporation of low molecular weight condensation products, comprising:
carrying out a polycondensation reaction in a conical, jacket-heated vessel having a helical or double-helical stirrer, the vessel having a conical section with an opening angle between 20 and 120°.

32. The process according to claim 31, wherein the opening angle is between 30 and 60°.

33. The process according to claim 31, wherein the helical or double-helical stirrer has a gradient of between 12 and 75°.

34. The process according to claim 31, wherein the helical or double-helical stirrer has a gradient of between 15 and 45°.

35. A process for batchwise preparation of condensation polymers from an oligomeric precursor with elimination and evaporation of low molecular weight condensation products, comprising:
carrying out a polycondensation reaction in a conical, jacket-heated vessel having a V-shaped anchor stirrer adapted to the vessel cross section, the vessel having a conical section with an opening angle between 20 and 120°.

36. The process according to claim 31, wherein an upper region of the vessel comprises a cylindrical section equipped with a heating jacket, the cylindrical section having a height less than or equal to 1.6 times a height of the conical section.

37. The process according to claim 31, wherein an upper region of the vessel comprises a cylindrical section equipped with a heating jacket, the cylindrical section having a height less than or equal to 0.8 times a height of the conical section.

38. The process according to claim 31, further comprising:
driving the stirrer to change a rotation rate in stages or steplessly and to move counter to an original direction of rotation.

39. The process according to claim 31, further comprising:
varying a vertical position of the stirrer to move the stirrer between 3 and 25 mm from a wall.

40. The process according to claim 31, further comprising:
varying a vertical position of the stirrer to move the stirrer between 4 and 15 mm from a wall.

41. The apparatus according to claim 25, wherein an upper region of the vessel comprises a cylindrical section equipped with a heating jacket, the cylindrical section having a height less than or equal to 1.6 times a height of the conical section.

42. The apparatus according to claim 25, wherein an upper region of the vessel comprises a cylindrical section equipped with a heating jacket, the cylindrical section having a height less than or equal to 0.8 times a height of the conical section.

43. The apparatus according to claim 25, wherein the stirrer is configured to be driven to change a rotation rate in stages or steplessly and to move counter to an original direction of rotation.

44. The apparatus according to claim 25, wherein the stirrer is configured to be positioned to vary a vertical position of the stirrer to move the stirrer between 3 and 25 mm from a wall.

45. The apparatus according to claim 25, wherein the stirrer is configured to be positioned to vary a vertical position of the stirrer to move the stirrer between 4 and 15 mm from a wall.

46. The process according to claim 35, wherein an upper region of the vessel comprises a cylindrical section equipped with a heating jacket, the cylindrical section having a height less than or equal to 1.6 times a height of the conical section.

47. The process according to claim 35, wherein an upper region of the vessel comprises a cylindrical section equipped with a heating jacket, the cylindrical section having a height less than or equal to 0.8 times a height of the conical section.

48. The process according to claim 35, further comprising:
driving the stirrer to change a rotation rate in stages or steplessly and to move counter to an original direction of rotation.

49. The process according to claim 35, further comprising:
varying a vertical position of the stirrer to move the stirrer between 3 and 25 mm from a wall.

50. The process according to claim 35, further comprising: varying a vertical position of the stirrer to move the stirrer between 4 and 15 mm from a wall.

51. The apparatus according to claim 21, wherein the vessel is configured to be heated.

52. The apparatus according to claim 25, wherein the anchor stirrer comprises a plurality of guide plates.

53. The process according to claim 31, wherein the vessel is configured to be heated.

54. The process according to claim 35, wherein the anchor stirrer comprises a plurality of guide plates.
